(19) United States
(12) Patent Application Publication
(10) Pub. No.: US 2005/0154581 A1
(43) Pub. Date: Jul. 14, 2005

(54) Speech recognition method

(75) Inventors: Alexandre Ferrieux, Pleumeur Bodou (FR); Lione Delphin-Poulat, Lannion (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: FRANCE TELECOM SA, PARIS (FR)

(21) Appl. No.: 10/509,651

(22) PCT Filed: Mar. 19, 2003
(86) PCT No.: PCT/FR03/00653

(30) Foreign Application Priority Data
Mar. 29, 2002 (FR) 02/04285

(51) Int. Cl. G10L 11/00

(52) U.S. Cl. 704/200

(57) ABSTRACT

Input data are translated into at least one output sentence by a decoding step which sub-lexical entities represented by the input data are identified by a first model. During decoding, as the sub-lexical entities are identified and with reference to at least one second mode, various possible combinations of the sub-lexical entities are generated. Plural possible combinations of the sub-lexical entities are stored. The most likely possible combination is intended to form the lexical output sequence.

The present invention concerns a method of translating input data into at least one lexical output sequence, including a step of decoding input data during which lexical entities which the said data represent are identified by means of at least one model.

Such methods are commonly used in speech recognition applications, where at least one model is used for recognising acoustic symbols present in the input data, a symbol being able to consist for example of a set of vectors of parameters of a continuous acoustic space, or a label allocated to a sub-lexical entity.

In certain applications, the term “lexical” will apply to a sentence considered as a whole, as a series of words, and the sub-lexical entities will then be words, whilst in other applications the term “lexical” will apply to a word, and the sub-lexical entities will then be phonemes or syllables able to form such words, if these are of a literal in nature, or figures, if the words are numerical in nature, that is to say numbers.

A first approach for carrying out speech recognition consists of using a particular type of model which has a regular topology and is intended to learn all the variant pronunciations of each lexical entity, that is to say for example a word, included in the model. According to this first approach, the parameters of a set of acoustic vectors peculiar to each input signal corresponding to an unknown word must be compared with sets of acoustic parameters each corresponding to one of the very many symbols contained in the model, in order to identify a modelled symbol to which the input symbol most likely corresponds. Such an approach in theory guarantees a high degree of recognition if the model used is well designed, that is to say almost exhaustive, but such quasi-exhaustiveness can be obtained only at the cost of a long process of learning of the model, which must assimilate an enormous quantity of data representing all the variant pronunciations of each of the words included in this model. This learning is in principle carried out by having all the words in a given vocabulary pronounced by a large number of persons, and recording all the variant pronunciations of these words. It is clear that the construction of a quasi-exhaustive lexical model cannot in practice be envisaged for vocabularies having a size greater than a few hundreds of words.

A second approach has been designed for the purpose of reducing the learning time necessary for the speech recognition applications, a reduction which is essential for translation applications on very large vocabularies which may contain several hundreds of thousands of words, the said second approach consisting of effecting a factorisation of the lexical entities, considering them to be collections of sub-lexical entities, generating a sub-lexical model modelling the said sub-lexical entities with a view to allowing their identification in the input data, and an articulation model modelling various possible combinations of these sub-lexical entities. According to this second approach, a new dynamic model forming the articulation model is formed from each sub-lexical entity newly identified in the input data, the said dynamic model taking account of all the collections made possible starting from the sub-lexical entity in question, and determines a likelihood value for each possible collection.

Such an approach, defined for example in Chapter 16 of the manual “Automatic Speech and Speaker Recognition”, published by Kluwer Academic Publishers, makes it possible to considerably reduce, compared with the model used in the context of the first approach described above, the individual durations of the learning processes of the sub-lexical model and of the articulation model, since each of these models has a simple structure compared with the lexical model used in the first approach.

However, in the majority of known implementations of the second approach described above, the sub-lexical model is duplicated on many occasions in the articulation model. This can easily be understood by considering an example where the lexical unit is a sentence and the sub-lexical units are words. If the articulation model is of a bigramme type, that is to say it takes account of possibilities of assembly of two successive words and probabilities of existence of such assemblies, each word retained at the end of the identification substep will have to be studied, with reference to the articulation model, with all the other words retained which may have preceded the word in question. If P words have been retained at the end of the identification substep, P pairs of words will have to be constructed for each Word to be identified, with P values of probability of existence, each associated with a possible pair. In the case of a more realistic articulation model of the trigramme type, which takes account of possibilities of assembly of three successive words and probabilities of existence of such assemblies, the articulation model will have to comprise, for each word to be identified, P times P triplets of words with as many existence probability values. The articulation models used in the second approach therefore have a simple structure but represent a considerable volume of data to be stored, updated and consulted. It will easily be understood that the creation and operation of such models gives rise to memory accesses whose management is made complex by the volume of data to be processed and by the distribution of the said data. In applications of the natural language type, for which more realistic models of the N-gramme type, where N is usually greater than two, are used, the memory accesses mentioned previously have execution times which are incompatible with constraints of the “real-time” type requiring very rapid memory accesses.

In addition, each word can itself be considered vis-á-vis syllables or phonemes which make it up as a lexical entity with a level lower than that of a phrase, a lexical entity for the modelling of which it is also necessary to have recourse to an articulation model of the N-gramme type with several tens of possible sub-lexical entities in the case of phonemes.

It is clear that the many duplications of the sub-lexical models to which the articulation models have recourse in the known implementations of the second approach prohibit the use of the latter in speech recognition applications in the context of applications of the type involving very large vocabularies, which contain several hundreds of thousands of words.

The aim of the invention is to remedy this drawback to a great extent by proposing a translation method which does not require many duplications of sub-lexical models in order to validate collections of sub-lexical entities, and thus simplifies the implementation of the said translation method, and in particular the management of memory accesses useful for this method.

This is because a translation method according to the introductory paragraph, including a decoding step during which sub-lexical entities whose input data are representative are identified by means of a first model constructed on the basis of predetermined sub-lexical entities, and during which there are generated, as the sub-lexical entities are identified and with reference to at least one second model constructed on the basis of lexical entities, various possible combinations of the said sub-lexical entities, is characterised according to the invention in that the decoding step includes a substep of storing a plurality of possible combinations of the said sub-lexical entities, the most likely combination being intended to form the lexical output sequence.

Because various collections of sub-lexical entities are stored as these entities are produced, it is no longer necessary to construct, after identification of each of the said sub-lexical entities, a dynamic model including all the possible sub-lexical entities, which makes it possible to avoid the duplications mentioned above and the memory management problems relating thereto.

The possibility of storing several different combinations makes it possible to keep a trace of several possible collections of sub-lexical entities, each having a likelihood peculiar to the moment where this collection is generated, the said likelihood being able to be effected favourably or unfavourably after analysis of lexical sub-entities subsequently produced. Thus a selection of a collection having the greatest likelihood at a given moment, but which will finally be judged to be unlikely in the light of subsequent sub-lexical entities, will not cause a systematic elimination of other collections, which may finally prove to be more pertinent. This variant of the invention therefore makes it possible to keep data representing, in the form of various histories, various interpretations of the input data, interpretations, the most likely of which can be identified and retained in order to form the lexical output sequence when all the sub-lexical entities have themselves been identified.

In a particular embodiment of this variant of the invention, the storage of a combination is subject to a validation carried out with reference at least to the second model.

This embodiment makes it possible to effect in a simple manner a filtering of the collections which appear to be unlikely in the light of the second model. Only the most plausible collections will be retained and stored, the other collections not being stored and therefore not subsequently taken into consideration.

In a variant of this embodiment, the storage validation can be effected with reference to several models with the equivalent and/or different levels, a level taking account of the sub-lexical, lexical or grammatical nature of a model.

In a particularly advantageous embodiment of this variant of the invention, a validation of storage of a combination is accompanied by an attribution to the combination to be stored of a probability value representing the likelihood of the said combination.

This embodiment makes it possible to modulate the binary nature of the filtering carried out by the validation or the absence of validation of the storage of a combination, allocating a quantitative assessment to each combination stored. This will afford a better assessment of the likelihood of various combinations which will have been stored, and therefore a better-quality translation of the input data.

It will also be possible to provide for various validation operations relating to various combinations relating to one and the same state of the first model to be executed contiguously in time.

This will make it possible to reduce still further the volume of the memory accesses and the calculation duplications, processing in one go an entire family of information which it would otherwise be necessary to store and read on a number of occasions.

In a particular embodiment of the invention, the decoding step uses a Viterbi algorithm applied to a first Markov model consisting of sub-lexical entities, under the dynamic control of a second Markov model representing possible combinations of sub-lexical entities.

This embodiment is advantageous in that it uses tried and tested means individually known to persons skilled in the art, the dynamic control obtained by virtue of the second Markov model making it possible to validate the collections of sub-lexical entities as the said entities are identified by means of the Viterbi algorithm which avoids having to construct, after identification of each sub-lexical entity, a new dynamic model repeating all the possible sub-lexical entities similar to those used in the known implementations of the second approach mentioned above.

The invention also concerns an acoustic signal recognition system implementing a method as described above.

The characteristics of the invention mentioned above, as well as others, will emerge more clearly from a reading of the following description of an example embodiment, the said description being given in relation to the accompanying drawings, amongst which:

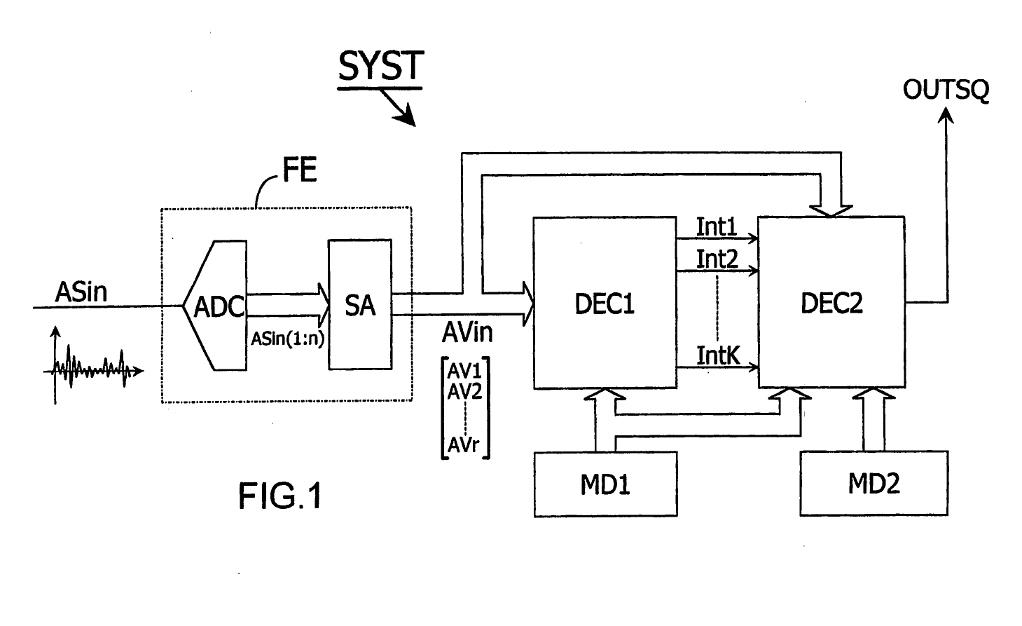

FIG. 1 is a functional diagram describing an acoustic recognition system in which a method according to the invention is implemented,

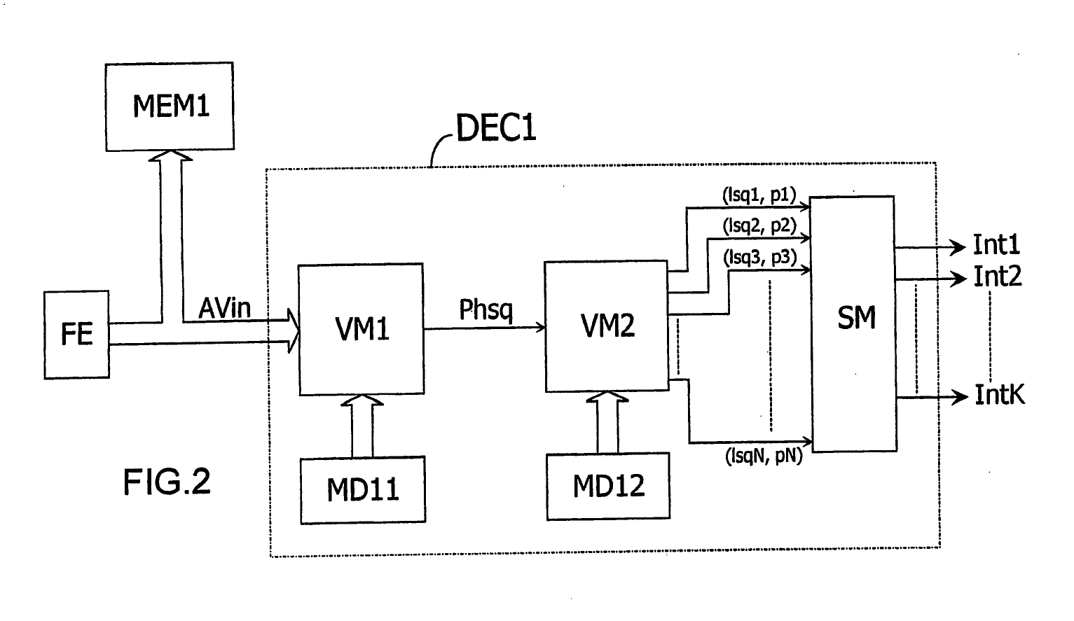

FIG. 2 is a functional diagram describing a decoder intended to execute a first decoding step in this particular embodiment of the invention; and

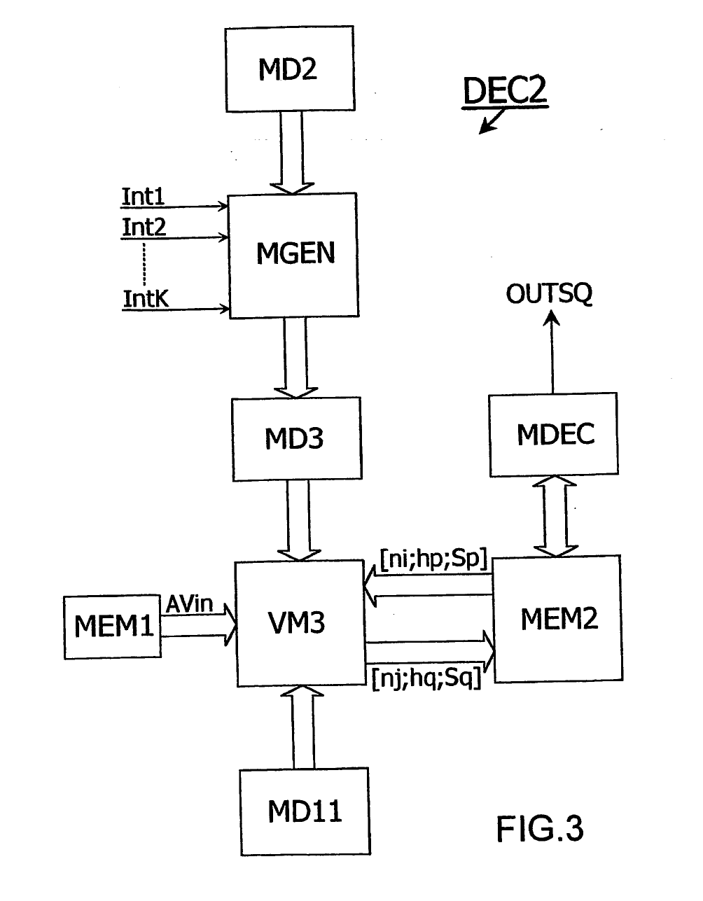

FIG. 3 is a functional diagram describing a decoder intended to execute a second decoding step in accordance with the method according to the invention.

FIG. 1 depicts schematically an acoustic recognition system SYST according to a particular embodiment of the invention, intended to translate an acoustic input signal ASin into a lexical output signal OUTSQ. The input signal ASin consists of an analogue electronic signal, which may come for example from a microphone, not shown in the figure. In the embodiment described here, the system SYST includes an input stage FE, containing an analogue to digital conversion device ADC, intended to supply a digital signal ASin(1:n), formed from samples ASin(1), ASin(2) . . . ASin(n) each coded in b bits, and representing the acoustic input signal ASin, and a sampling module SA, intended to convert the digitised acoustic signal ASin(1:n) into a sequence of acoustic vectors AVin, each vector being provided with components AV1, AV2 . . . AVr where r is the dimension of an acoustic space defined for a given application for which the translation system SYST is intended, each of the components AVi (for i=1 to r) being evaluated according to characteristics peculiar to this acoustic space.

The system SYST also includes a first decoder DEC1, intended to supply a selection Int1, Int2 . . . IntK of possible interpretations of the sequence of acoustic vectors AVin with reference to a model MD1 constructed on the basis of predetermined sub-lexical entities.

The system SYST also includes a second decoder DEC2 in which a translation method according to the invention is implemented with a view to analysing input data consisting of the acoustic vectors AVin with reference to a first model constructed on the basis of predetermined sub-lexical entities, for example the model MD1, and with reference to at least one second model MD2 constructed on the basis of lexical entities representing the interpretations Int1, Int2 . . . IntK selected by the first decoder DEC1, with a view to identifying the one of the said interpretations which is to constitute the lexical output sequence OUTSQ.

FIG. 2 depicts in more detail the first decoder DEC1, which includes a first Viterbi machine VM1, intended to execute a first substep of decoding the sequence of acoustic vectors AVin representing the acoustic input signal and previously generated by the input stage FE, which sequence will also advantageously be stored in a storage unit MEM1 for reasons which will emerge later in the disclosure. The first decoding substep is carried out with reference to a Markov model MD11 enabling in a loop all the sub-lexical entities, preferably all the phonemes of the language into which the acoustic input signal is to be translated if it is considered that the lexical entities are words, the sub-lexical entities being represented in the form of predetermined acoustic vectors.

The first Viterbi machine VM1 is able to restore a sequence of phonemes Phsq which constitutes the closest phonetic translation of the sequence of acoustic vectors AVin. The subsequent processings carried out by the first decoder DEC1 will thus take place at a phonetic level, rather than at the vector level, which considerably reduces the complexity of the said processings, each vector being a multi-dimensional entity having r components, whilst a phoneme can in principle be identified by a uni-dimensional label which is peculiar to it, such as for example a label “OR” allocated to an oral vowel “u”, or a label “CH” allocated to an unvoiced fricative consonant “∫”. The sequence of phonemes Phsq generated by the first Viterbi machine VM1 thus consists of a succession of labels which can be manipulated more easily than the acoustic vectors would be.

The first decoder DEC1 includes a second Viterbi machine VM2 intended to execute a second substep of decoding the sequence of phonemes Phsq generated by the first Viterbi machine VM1. This second decoding step is carried out with reference to a Markov model PLMM consisting of sub-lexical transcriptions of lexical entities, that is to say in this example phonetic transcriptions of words present in the vocabulary of the language into which the acoustic input signal is to be translated. The second Viterbi machine is intended to interpret the sequence of phonemes Phsq, which is very noisy because the model MD11 used by the first Viterbi machine VM1 is of great simplicity, and uses predictions and comparisons between series of labels of phonemes contained in the sequence of phonemes Phsq and various possible combinations of labels of phonemes provided for in the Markov model MD12. Although a Viterbi machine normally restores only the sequence which has the greatest probability, the second Viterbi machine VM2 used here will advantageously restore all the sequences of phonemes 1sq1, 1sq2 . . . 1sqN that the said second machine VM2 has been able to reconstitute, with associated probability values p1, p2 . . . pN which will have been calculated for the said sequences and will represent the reliability of the interpretations of the acoustic signal that these sequences represent

All the possible interpretations 1sq1, 1sq2 . . . 1sqN being automatically made available at the end of the second decoding substep, a selection of K interpretations Int1, Int2 . . . IntK which have the highest probability values is easy whatever the value of K which has been chosen.

The first and second Viterbi machines VM1 and VM2 can function in parallel, the first Viterbi machine VM1 then gradually generating labels of phonemes which will immediately be taken into account by the second Viterbi machine VM2, which makes it possible to reduce the total delay perceived by a user of the system necessary for combining the first and second decoding substeps by enabling the use of all the calculation resources necessary for the functioning of the first decoder DEC1 as soon as the acoustic vectors AVin representing the input acoustic signal appear, rather than after they have been entirely translated into a complete sequence of phonemes Phsq by the first Viterbi machine VM1.

FIG. 3 shows in more detail a second decoder DEC2 according to a particular embodiment of the invention. This second decoder DEC2 includes a third Viterbi machine VM3 intended to analyse the sequence of acoustic vectors AVin representing the acoustic input signal previously stored in the storage unit MEM1.

To this end, the third Viterbi machine VM3 is intended to execute an identification substep during which the sub-lexical entities whose acoustic vectors AVin are representative are identified by means of a first model constructed on the basis of predetermined sub-lexical entities, in this example the Markov model MD11 used in the first decoder and already described above.

The third Viterbi machine VM3 also generates, as these entities are identified and with reference to at least one specific Markov model MD3 constructed on the basis of lexical entities, various possible combinations of the sub-lexical entities, the most likely combination being intended to form the lexical output sequence OUTSQ. The specific Markov model MD3 is here specifically generated for this purpose by a model creation module MGEN and solely represents possible collections of phonemes within the sequences of words formed by the various phonetic interpretations Int1, Int2, . . . IntK of the acoustic input signal which are delivered by the first decoder, which collections are represented by sub-models extracted from the lexical model MD2 by the model creation module MGEN. The specific Markov model MD3 therefore has a restricted size because of its specific nature.

When the third Viterbi machine VM3 is in a given state ni, with which a history hp and a probability value Sp are associated, if there exists in the Markov model MD11 a transition from the state ni to a state nj provided with a marker M, which marker being able to for example to consist of the label of a phoneme whose last state is ni or a phoneme whose first state is nj, the third Viterbi machine VM3 will associate with the state nj a new history hq and a new probability value Sq which will be generated with reference to the specific model MD3, on the basis of the history hp, its associated probability value Sp and the marker M, the probability value Sp also being able to be modified also with reference to the Markov model MD11. This operation will be repeated for all the histories associated with the state ni. If one and the same history hk is associated on several occasions with the same state of the Markov model MD11 with various probability values Sp1, . . . Spq, in accordance with the Viterbi algorithm, only the highest probability value will be kept and allocated as a probability value Sp to the history hk.

Each state nj is stored in a storage unit MEM2 with its various histories hq and a probability value Sq peculiar to each history, until the third Viterbi machine VM3 has identified all the phonemes contained in the sequence of acoustic input vectors AVin and has reached a last state nf along with a plurality of histories hf representing the various possible combinations of the phonemes identified. The one from amongst these histories which has been allocated the highest probability value Sfₘₐₓ will be retained by a memory decoder MDEC in order to form the lexical output sequence OUTSQ.

The Markov model MD3 therefore carries out a dynamic check making it possible to validate the assemblies of phonemes as the said phonemes identified by the third Viterbi machine VM3, which avoids having to duplicate these phonemes in order to form models such as those used in the known implementations of the second approach mentioned above. In this way, the accesses to the storage units MEM1 and MEM2, as well as to the various Markov models MD11, MD12, MD2 and MD3 used in the example described above require management which is not very complex, because of the simplicity of the structure of the said models and of information intended to be stored and read in the said storage units. These memory accesses can therefore be executed sufficiently rapidly to make the system described in this example able to perform translations in real time of acoustic input data in lexical output sequences.

Although the invention has been described here in the context of an application within a system including two decoders disposed in a cascade, it can be entirely envisaged, in other embodiments of the invention, using only a single decoder similar to the second decoder described above, which may for example perform an acoustico-phonetic analysis and store, as the phonemes are identified, various possible combinations of the said phonemes, the most likely combination of phonemes being intended to form the lexical output sequence.

1-6. (canceled)

7. Method of translating input data into at least one lexical output sequence, the method comprising decoding input data so (a) sub-lexical entities represented by the said data are identified by using a first model determined by predetermined sub-lexical entities, and (b) various possible combinations of the said sub-lexical entities are generated, as the sub-lexical entities are identified and with reference to at least one second model constructed on the basis of lexical entities, including storing a plurality of possible combinations of the said sub-lexical entities, the most likely combination being intended to form the lexical output sequence.

8. Translation method according to claim 7, further including validating, with reference at least to the second model, the storage of a combination.

9. Translation method according to claim 8, wherein the validating of the storage of a combination is accompanied by an allocation to the combination to be stored of a probability value representing the likelihood of the said combination.

10. Translation method according to claim 9, wherein various validation operations relating to various combinations relating to one and the same state of the first model are executed contiguously in time.

11. Translation method according to claim 8, wherein various validation operations relating to various combinations relating to one and the same state of the first model are executed contiguously in time.

12. Translation method according to claim 7, wherein the decoding step uses a Viterbi algorithm applied to a first Markov model having sub-lexical entities, under the dynamic control of a second Markov model representing possible combinations of sub-lexical entities.

13. Speech recognition system using the translation method according to claim 7.

14. Speech recognition system using the translation method according to claim 8.

15. Speech recognition system using the translation method according to claim 9.

16. Speech recognition system using the translation method according to claim 10.

17. Speech recognition system using the translation method according to claim 11.

18. Speech recognition system using the translation method according to claim 12.
